(19) United States
(12) Patent Application Publication
(10) Pub. No.: US 2026/0147507 A1
(43) Pub. Date: May 28, 2026

(54) STORAGE DEVICE, NON-VOLATILE MEMORY DEVICE AND METHOD OF OPERATING NON-VOLATILE MEMORY DEVICE

(71) Applicant: Samsung Electronics Co., Ltd., Suwon-si (KR)

(72) Inventor: Yong-Taek JEONG, Suwon-si (KR)

(73) Assignee: Samsung Electronics Co., Ltd., Suwon-si (KR)

(21) Appl. No.: 19/319,886

(22) Filed: Sep. 5, 2025

(30) Foreign Application Priority Data
Nov. 28, 2024 (KR) 10-2024-0173674

(51) Int. Cl. G06F 3/06

(52) U.S. Cl. CPC G06F 3/0659; G06F 3/0611; G06F 3/0679

(57) ABSTRACT

A storage device includes a controller configured to transmit an insert queue command including an operation command and a non-volatile memory device including a first command queue and a second command queue, and configured to store the operation command in one of the first command queue and the second command queue. The non-volatile memory device may be configured to suspend an operation corresponding to a first operation command stored in the first command queue and perform an operation corresponding to a second operation command when the second operation command is stored in the second command queue while performing the operation corresponding to the first operation command.

### CROSS-REFERENCE TO RELATED APPLICATION(S)

This U.S. non-provisional application claims priority under 35 USC § 119 to Korean Patent Application No. 10-2024-0173674, filed on Nov. 28, 2024, in the Korean Intellectual Property Office, the disclosure of which is herein incorporated by reference in its entirety.

### BACKGROUND

Some example embodiments relate to semiconductor memory devices and, more particularly, to a storage device, a non-volatile memory device, and a method of operating the non-volatile memory device.

Semiconductor memory devices may be broadly classified into volatile memory devices and non-volatile memory devices. Volatile memory devices (for example, dynamic random-access memory (DRAM) or static random-access memory (SRAM)) may offer higher read and write speeds than most non-volatile memory devices, but volatile memory devices lose their stored data when their power supplies are interrupted, while non-volatile memory devices may retain their stored data even when their power supplies are interrupted. A representative example of a non-volatile memory device is a flash memory device.

With the advancement of technology, the growing demand for higher operating speeds in flash memory devices has driven efforts to separate command/address pins CA and data pins DQ, even in non-volatile memory. Methods to improve the performance of storage devices, including non-volatile memory, are being developed using such a separate command/address (SCA) interface.

### SUMMARY

Some example embodiments provide a storage device, a non-volatile memory device, and a method of operating the nonvolatile memory device, all of which offer improved performance.

According to at least one example embodiment, a storage device includes a controller configured to transmit an insert queue command, the insert queue command including an operation command and a non-volatile memory device including a first command queue and a second command queue, the non-volatile memory device configured to store the operation command in one of the first command queue and the second command queue. The non-volatile memory device may be configured to perform an operation corresponding to a first operation command stored in the first command queue, store a second operation command in the second command queue while performing the operation corresponding to the first operation command, and suspend the operation corresponding to the first operation command and perform an operation corresponding to the second operation command when the second operation command is stored in the second command queue.

The controller may be configured to transmit the insert queue command to the non-volatile memory device through a command/address line separate from a data line.

The insert queue command may include queue type information corresponding to one of the first command queue and the second command queue, and the non-volatile memory device may be configured to store the operation command in one of the first command queue or the second command queue based on the queue type information.

The first operation command may be at least one of a program command or an erase command, and the second operation command may be a read command.

The non-volatile memory device may be configured to resume the operation corresponding to the first operation command when the operation corresponding to the second operation command is completed.

The insert queue command may include resume information indicating whether to resume an operation corresponding to the operation command included in the insert queue command. The non-volatile memory device may be configured to resume the operation corresponding to the first operation command in response to the operation corresponding to the second operation command being completed, when the resume information corresponds to the first operation command has a first value, and refrain from resuming the operation corresponding to the first operation command in spite of the operation corresponding to the second operation command being completed, when the resume information corresponding to the first operation command and has a second value different from the first value.

The non-volatile memory device may include a special function register (SFR) for setting whether to resume an operation corresponding to a suspended operation command. The non-volatile memory device may be configured to resume the operation corresponding to the first operation command in response to the operation corresponding to the second operation command being completed and a first value is set in the SFR, and refrain from resuming the operation corresponding to the first operation command in spite of completion of the operation corresponding to the second operation command being completed when a second value is set in the SFR, the second value different from the first value.

The controller may be configured to transmit a queue status read command to the non-volatile memory device, and the non-volatile memory device may be configured to transmit status information of the first command queue and the second command queue to the controller in response to the queue status read command. The status information may include information on a processing status of each of the operation commands stored in the first command queue and the second command queue.

The non-volatile memory device may be configured to, when a plurality of operation commands are stored in each of the first command queue and the second command queue, prioritize at least a portion of the operation commands stored in the second command queue over the operation commands stored in the first command queue.

According to at least one example embodiment, a non-volatile memory device includes memory cell array and a control circuit including a first command queue and a second command queue, and configured to cause the memory cell array to perform operations corresponding to operation commands stored in the first command queue and the second command queue. The control circuit may be configured to perform an operation corresponding to a first operation command stored in the first command queue, store a second operation command in the second command queue while performing the operation corresponding to the first operation command, and suspend the operation corresponding to the first operation command stored in the first command queue and perform an operation corresponding to the second operation command when the second operation command is stored in the second command queue.

The operation commands may be respectively included in insert queue commands and provided to the non-volatile memory device through a command/address line separate from a data line.

Each of the insert queue commands may include queue type information corresponding to one of the first command queue or the second command queue, and the control circuit may be configured to store each of the operation commands in one of the first command queue and or second command queue based on the queue type information.

The control circuit may be configured to resume the operation corresponding to the first operation command when the operation corresponding to the second operation command is completed.

Each of the insert queue commands may include resume information indicating whether to resume an operation corresponding to an operation command included in the insert queue command. The control circuit may be configured to resume the operation corresponding to the first operation command in response to the operation corresponding to the second operation command being completed when the resume information corresponds to the first operation command and has a first value, and refrain from resuming the operation corresponding to the first operation command in spite of completion of the operation corresponding to the second operation command, when the resume information corresponding to the first operation command has a second value different from the first value.

The non-volatile memory device may include a special function register (SFR) for setting whether to resume an operation corresponding to a suspended operation command. The control circuit may be configured to resume the operation corresponding to the first operation command in response to the operation corresponding to the second operation command being completed and a first value is set in the SFR, and refrain from resuming the operation corresponding to the first operation command in spite of completion of the operation corresponding to the second operation command, when a second value is set in the SFR, the second value different from the first value.

The control circuit may be configured to store each of the operation commands in one of the first command queue and the second command queue based on the queue type information and to decode the operation commands stored in the first command queue and the second command queue and determine a processing order of the decoded operation commands.

The control circuit may be configured to, when a plurality of operation commands are stored in each of the first command queue and the second command queue, prioritize at least a portion of the operation commands stored in the second command queue over the operation commands stored in the first command queue.

The control circuit may be configured to transmit status information of the first command queue and the second command queue to a controller in response to a queue status read command being received from the controller, and the status information may include information on a processing status of each of the operation commands stored in the first command queue and the second command queue.

According to at least one example embodiment, a method of operating a non-volatile memory device includes storing a first operation command in a first command queue when a first insert queue command including the first operation command is received, performing an operation corresponding to the first operation command, storing a second operation command in a second command queue in response to a second command comprising the second operation command being received, the storing the second operation command performed while performing the operation corresponding to the first operation command, and suspending the operation corresponding to the first operation command and performing an operation corresponding to the second operation command in response to the second operation command being stored in the second command queue.

The method may include resuming the operation corresponding to the first operation command in response to completion of the operation corresponding to the second operation command.

### BRIEF DESCRIPTION OF DRAWINGS

FIG. 1 is a block diagram illustrating the configuration of a storage device according to at least one example embodiment.

FIG. 2 is a diagram illustrating performance improvement of the storage device according to some example embodiments.

FIG. 3 is a block diagram illustrating the configuration of a controller according to at least one example embodiment.

FIG. 4 is a block diagram of a non-volatile memory device according to at least one example embodiment.

FIG. 5 is a schematic block diagram illustrating a structure of a non-volatile memory device according to at least one example embodiment.

FIG. 6 is a circuit diagram illustrating an example of a structure of a memory block constituting a memory cell array of FIG. 4.

FIG. 7 is a diagram illustrating an example of a packet configuration applied to a separate command/address (SCA) protocol according to at least one example embodiment.

FIG. 8 is a diagram illustrating the structure of an insert queue command according to at least one example embodiment.

FIG. 9 is a block diagram illustrating the configuration of a control circuit according to at least one example embodiment.

FIG. 10 is a block diagram illustrating the configuration of a non-volatile memory device according to at least one example embodiment.

FIG. 11 is a block diagram illustrating the configuration of a control circuit according to at least one example embodiment.

FIG. 12 is a block diagram illustrating the configuration of a control circuit according to at least one example embodiment.

FIG. 13 is a diagram illustrating an example of a queue status read operation according to at least one example embodiment.

FIG. 14 is a flowchart illustrating a method of operating a non-volatile memory device according to at least one example embodiment.

### DETAILED DESCRIPTION

In the present disclosure, the terms such as “first” and “second” as used herein may modify various elements regardless of an order and/or importance of the corresponding elements, and do not limit the corresponding elements. These terms may be used for the purpose of distinguishing one element from another element. Additionally, when describing the example embodiments with reference to the accompanying drawings, like reference numerals refer to like elements and a repeated description related thereto will be omitted.

Additionally, unless indicated otherwise, functional elements that process at least one function or operation may be implemented in processing circuitry such as hardware, software, and/or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc., and/or electronic circuits including said components.

It will be understood that, when an element (for example, a first element) is “coupled with/to” or “connected to” another element (for example, a second element), the element may be directly coupled with/to another element, and there may be an intervening element (for example, a third element) between the element and another element.

Hereinafter, some example embodiments will be described in detail to enable those skilled in the art to readily implement the present disclosure.

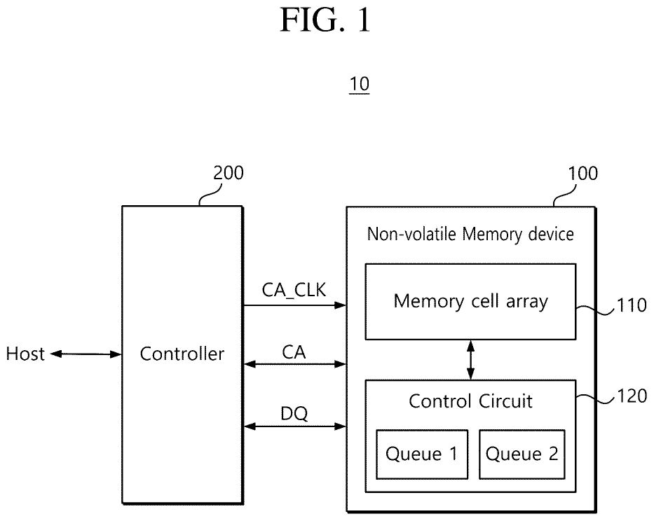

FIG. 1 is a block diagram illustrating the configuration of a storage device according to at least one example embodiment. Referring to FIG. 1, the storage device 10 may include a controller 200 and a non-volatile memory device 100.

For example, each of the controller 200 and the non-volatile memory device 100 may be provided as a single chip, a single package, or a single module. Alternatively, the controller 200 and the non-volatile memory device 100 may be collectively configured as a single chip, a single package, or a single module. The controller 200 and the non-volatile memory device 100 may constitute a storage device such as an embedded memory, a memory card, a memory stick, or a solid-state drive (SSD). An interface between the non-volatile memory device 100 and the controller 200 may be implemented to comply with standard protocols such as Toggle or ONFI, but the example embodiments are not limited thereto.

The controller 200 is configured to control the operation of the non-volatile memory device 100. For example, the controller 200 may write data to the non-volatile memory device 100 or read data, stored in the non-volatile memory device 100, in response to a request from a host. To this end, the controller 200 may generate a command, an address, and a clock signal CA_CLK to access the non-volatile memory device 100.

According to at least one example embodiment, the controller 200 may access the non-volatile memory device 100 based on a separate command/address (hereinafter referred to as “SCA”) protocol. For example, the controller 200 may use a command/address line CA, separate from a data line DQ, to transmit commands and addresses.

For example, the controller 200 may transmit a program command and address to the non-volatile memory device 100 through the command/address line CA during a data program operation. The controller 200 may transmit program data to the non-volatile memory device 100 through the data line DQ. In addition, the controller 200 may transmit a read command and address to the non-volatile memory device 100 through the command/address line CA during a data read operation. The read data, output from the non-volatile memory device 100, may be provided to the controller 200 through the data line DQ. In addition, the controller 200 may transmit an erase command and address to the non-volatile memory device 100 through the command/address line CA during a data erase operation.

The controller 200 may use a clock signal CA_CLK to apply the SCA protocol. Various commands, addresses, or data may be synchronized with the clock signal CA_CLK and transmitted to the non-volatile memory device 100 through the command/address line CA.

According to at least one example embodiment, the controller 200 may transmit an insert queue command to the non-volatile memory device 100 through the command/address line CA. The insert queue command may be a command to store an operation command, such as the above-mentioned program command, read command, or erase command, in one of the command queues of the non-volatile memory device 100. To this end, the insert queue command may include queue type information corresponding to one of the command queues and the operation command.

The non-volatile memory device 100 is configured to exchange data with the controller 200 under the control of the controller 200. According to at least one example embodiment, the non-volatile memory device 100 may exchange data with the controller 200 based on the SCA protocol. For example, the non-volatile memory device 100 may receive commands and addresses from the controller 200 through the command/address line CA. For example, the non-volatile memory device 100 may receive a program command and address through the command/address line CA and data through the data line DQ, during a program operation. In addition, the non-volatile memory device 100 may receive a read command and address through the command/address line CA and output data through the data line DQ during a read operation. In addition, the non-volatile memory device 100 may receive an erase command and address through the command/address line CA during an erase operation.

The non-volatile memory device 100 may include a memory cell array 110 and a control circuit 120. The memory cell array 110 may include a plurality of memory cells, respectively connected to a plurality of bitlines and a plurality of wordlines. The memory cells may be implemented with various non-volatile memory elements such as one or more of a NAND flash memory, a NOR flash memory, a phase change RAM (PRAM), a resistive RAM (ReRAM), a magnetic RAM (MRAM), a ferroelectric RAM (FRAM), or the like. According to at least one example embodiment, the memory cells may be implemented in a three-dimensional array structure, such as a vertical NAND flash memory (VNAND), but the example embodiments are not limited thereto.

The control circuit 120 is configured to control the overall operation of the non-volatile memory device 100. The control circuit 120 may control the memory cell array 110 to perform an operations corresponding to an operation command. For example, the control circuit 120 may program data in the memory cell array 110 based on a program command and address. In addition, the control circuit 120 may read data, stored in the memory cell array 110, based on a read command and address. In addition, the control circuit 120 may erase data, stored in the memory cell array 110, based on an erase command and address.

For example, the control circuit 120 may include a plurality of command queues in which operation commands are stored and may control the memory cell array 110 to perform operations corresponding to the operation commands stored in each of the plurality of command queues. The plurality of command queues may have different priorities, respectively. The control circuit 120 may prioritize operation commands stored in command queues with relatively higher priorities, over those stored in command queues with relatively lower priorities.

According to at least one example embodiment, the control circuit 120 may include a first command queue Queue 1 and a second command queue Queue 2. When a second operation command is stored in the second command queue Queue 2 while the control circuit 120 is performing an operation corresponding to a first operation command stored in the first command queue Queue 1, the control circuit 120 may suspend an operation corresponding to the first operation command and perform an operation corresponding to the second operation command.

An example is provided in which a first insert queue command includes queue type information corresponding to the first command queue Queue 1 and a first operation command, and a second insert queue command includes queue type information corresponding to the second command queue Queue 2 and a second operation command. When the first insert queue command is received from the controller 200 through the command/address line CA, the control circuit 120 may store the first operation command in the first command queue Queue 1 based on the queue type information included in the first insert queue command and perform an operation corresponding to the first operation command. Then, when the second insert queue command is received from the controller 200 through the command/address line CA while performing the operation corresponding to the first operation command, the control circuit 120 may store the second operation command in the second command queue Queue 2 based on the queue type information included in the second insert queue command. When the second operation command is stored in the second command queue Queue 2, the control circuit 120 may suspend the ongoing operation corresponding to the first operation command and perform the operation corresponding to the second operation command.

According to at least one example embodiment, the control circuit 120 may resume the operation corresponding to the first operation command after the operation corresponding to the second operation command is completed.

As described above, the non-volatile memory device 100 may insert an operation command to be processed urgently into the high-priority second command queue Queue 2, thereby suspending a currently ongoing operation and prioritizing an operation to be processed urgently. In addition, according to at least one example embodiment, when the operation to be processed urgently is completed, the suspended operation may be automatically resumed.

According to at least one example embodiment, for example, a suspend-resume operation may be automatically performed through a higher-priority command queue among the command queues provided in the non-volatile memory device 100, so that the performance of the storage device 10 may be improved.

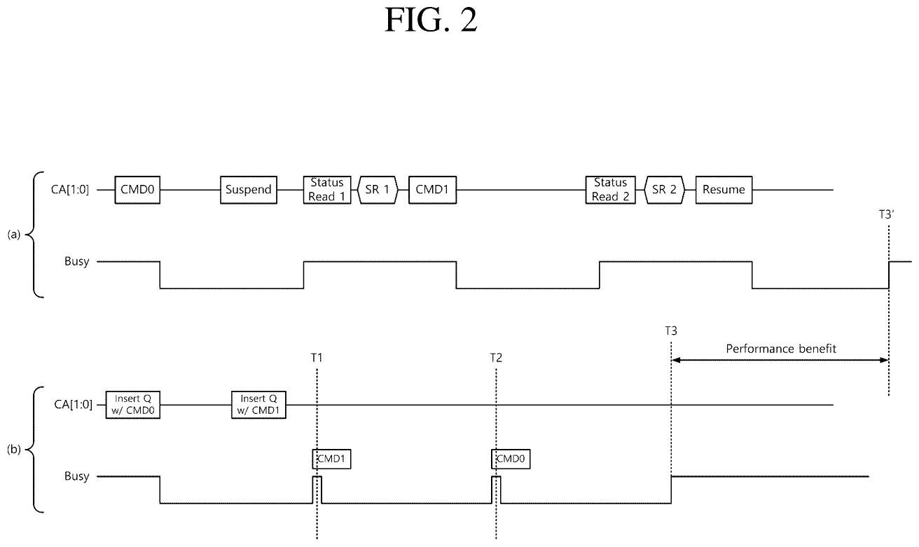

FIG. 2 is a diagram illustrating the performance improvement of a storage device according to some example embodiments. In FIG. 2, (a) illustrates an example in which a suspend-resume operation is performed in a comparative storage device, and (b) illustrates an example in which a suspend-resume operation is performed in the storage device 10 of FIG. 1. In FIG. 2, CA[1:0] represents a command or data applied to the command/address line, and Busy indicates an operating status of the non-volatile memory device. For example, a low-level Busy signal may indicate a status in which an operation command is being processed, while a high-level Busy signal may indicate a status in which processing a currently ongoing operation command is completed and the next operation command may be processed.

Referring to (a) in FIG. 2, the controller of a typical storage device may transmit a first operation command CMD0 to a non-volatile memory device. Accordingly, the non-volatile memory device of the typical storage device may perform an operation corresponding to the first operation command CMD0. The first operation command may be a command for, e.g., a program operation or an erase operation, but the example embodiments are not limited thereto. A program operation or an erase operation may require a larger amount of time than a read operation.

A situation, in which urgent processing of the second operation command CMD1 is required, may arise while the first operation command CMD0 is being processed in the non-volatile memory device. The second operation command CMD1 may be a read command, but the example embodiments are not limited thereto.

The controller may transmit a suspend command Suspend to the non-volatile memory device to suspend the processing of the first operation command CMD0. The controller may transmit a status read command Status Read 1 to check whether the operation corresponding to the first operation command CMD0 has been suspended (for example, whether the suspending operation has been completed). The suspending operation may involve, for example, discharging charges, accumulated in a floating gate of a memory cell, to perform a program operation or an erase operation.

The non-volatile memory device may transmit status read data SR 1 to the controller in response to the status read command Status Read 1. When it is confirmed, based on the status read data SR1, that the non-volatile memory device is ready to process the next command, the controller may transmit the second operation command CMD1 to the non-volatile memory device. Accordingly, the non-volatile memory device may process the second operation command CMD1.

To resume the suspended first operation command CMD0, the controller may use a status read command Status Read 2 to verify completion of the second operation command CMD1. When it is confirmed, based on the status read data SR2, that the non-volatile memory device is ready to process the next command, the controller may transmit a resume command Resume to the non-volatile memory device to resume an operation corresponding to the first operation command CMD0.

As described above, in the comparative storage device, a suspend command Suspend, status read commands Status Read 1 and Status Read 2, status read data SR1 and SR2, and a resume command Resume are exchanged between the controller and the non-volatile memory device to perform a suspend-resume operation.

Referring to (b) in FIG. 2, the controller 200 of the storage device 10 may transmit a first insert queue command including the first operation command CMD0 to the non-volatile memory device 100. Accordingly, the non-volatile memory device 100 may store the first operation command CMD0 in the first command queue Queue 1 and perform an operation corresponding to the first operation command CMD0.

When a situation arises in which urgent processing of a second operation command CMD1 is to be performed, the controller 200 may transmit a second insert queue command including the second operation command CMD1 to the non-volatile memory device 100.

When the second insert queue command is received while the operation corresponding to the first operation command CMD0 is being performed, the non-volatile memory device 100 may store the second operation command CMD1 in the second command queue Queue 2 and suspend the operation corresponding to the first operation command CMD0.

Then, when it is confirmed at time T1 that the operation corresponding to the first operation command CMD0 has been suspended (for example, the suspending operation has been completed), the non-volatile memory device 100 may perform the operation corresponding to the second operation command CMD1.

Then, when it is confirmed at time T2 that the operation corresponding to the second operation command CMD1 has been completed, the non-volatile memory device 100 may resume the operation corresponding to the first operation command CMD0.

As described above with reference to (b) in FIG. 2, according to at least one example embodiment, a queue interface including a plurality of command queues Queue 1 and Queue 2 may be implemented in the non-volatile memory device 100 and a suspend-resume operation may be performed using the queue interface. Unlike the illustration of (a) in FIG. 2, commands such as a suspend command Suspend, status read commands Status Read 1 and Status Read 2, and a resume command Resume are no longer necessary, so that the performance of the storage device 10 related to the suspend-resume operation may be improved.

T3′ represents time at which the suspend-resume operation is completed in a typical storage device, while T3 represents time at which the suspend-resume operation is completed in the non-volatile memory device 100 according to at least one example embodiment, demonstrating that performance is improved by a difference therebetween.

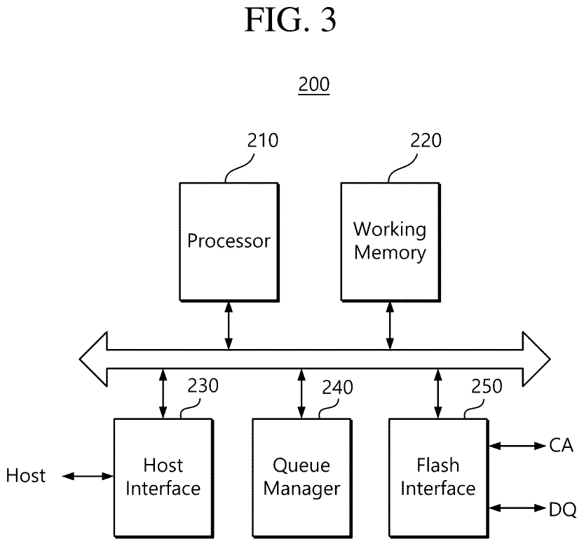

FIG. 3 is a block diagram illustrating the configuration of a controller according to at least one example embodiment. The controller 200 of FIG. 3 may correspond to the controller 200 of FIG. 1.

Referring to FIG. 3, the controller 200 may include a processor 210, a working memory 220, a host interface 230, a queue manager 240, and a flash interface 250. However, it will be understood that components of the controller 200 are not limited to those illustrated. For example, the controller 200 may further include a read-only memory (ROM) storing code data required for booting operations or an error correction code block (ECC) block.

The processor 210 may include, for example, a central processing unit (CPU), a microprocessor, or the like. The processor 210 is configured to execute firmware running on the controller 200. For example, the processor 210 may execute various types of firmware or software loaded into the working memory 220. In addition, the processor 210 may execute firmware or software responsible for core functions of the storage device 10, such as a host interface layer (HIL) or a flash translation layer (FTL).

Software (or firmware) may be loaded into the working memory 220 to control the controller 200. The software and data loaded into the working memory 220 may be executed or processed by the processor 210. The flash translation layer (FTL), not illustrated, driven by the processor 210 may perform functions such as address mapping, garbage collection, or wear leveling.

The host interface 230 is configured to provide interfacing between the host and the controller 200. The host and the controller 200 may be connected through one of various standardized interfaces. The standardized interfaces may include various interface protocols such as Advanced Technology Attachment (ATA) interface, Serial ATA (SATA) interface, external SATA (e-SATA) interface, Small Computer Small Interface (SCSI), Serial Attached SCSI (SAS), Peripheral Component Interconnection (PCI) interface, PCI-Express (PCI-E) interface, Universal Serial Bus (USB) interface, IEEE 1394 interface, Universal Flash Storage (UFS) interface, embedded MMC (eMMC) interface, NVMe interface, or the like.

The queue manager 240 is configured to perform operations related to the command queues Queue 1 and Queue 2 included in the non-volatile memory device 100.

For example, the queue manager 240 may generate an insert queue command. According to at least one example embodiment, the insert queue command may include queue type information corresponding to one of the command queues Queue 1 and Queue 2 included in the non-volatile memory device 100. In addition, the insert queue command may include an operation command. Accordingly, the non-volatile memory device 100 may store the operation command in a command queue corresponding to the queue type information, among the command queues Queue 1 and Queue 2. According to at least one example embodiment, the insert queue command may include an address related to the operation command.

According to at least one example embodiment, the insert queue command may further include resume information. The resume information may indicate whether to resume an operation corresponding to the operation command included in the insert queue command. For example, the resume information may have a first value corresponding to “Resume ON” or a second value corresponding to “Resume OFF.” The non-volatile memory device 100 may determine whether to resume a suspended operation command, based on the resume information. For example, when an operation on the first operation command is suspended and an operation on the second operation command is performed first, the non-volatile memory device 100 may determine whether to resume the operation corresponding to the first operation command, based on the resume information. When the resume information corresponding to the first operation command has the first value, the non-volatile memory device 100 may resume the operation corresponding to the first operation command in response to the operation corresponding to the second operation command being completed. When the resume information corresponding to the first operation command has the second value, the non-volatile memory device 100 may not resume the operation corresponding to the first operation command even after the operation corresponding to the second operation command is completed. For example, the queue manager 240 may determine whether to automatically resume the operation command included in the insert queue, based on the resume information.

The queue manager 240 may generate a queue status read command. The queue status read command may be a command requesting status information for each of the command queues Queue 1 and Queue 2 of the non-volatile memory device 100. The status information for each queue may include information on a processing status of the operation commands stored in each queue. The non-volatile memory device 100 may provide status information for each of the command queues Queue 1 and Queue 2 to the controller 200 in response to the queue status read command. This will be described in more detail later.

The flash interface 250 is configured to provide interfacing between the controller 200 and the non-volatile memory device 100. For example, data processed by the processor 210 may be stored in the non-volatile memory device 100 through the flash interface 250. In addition, data stored in the non-volatile memory device 100 may be provided to the controller 200 through the flash interface 250.

For example, the flash interface 250 may communicate with the non-volatile memory device 100 using a separate command/address (SCA) protocol. For example, an insert queue command or a queue status read command generated by the queue manager 240 may be transmitted to the non-volatile memory device 100 through a command/address line CA, separate from the data line DQ.

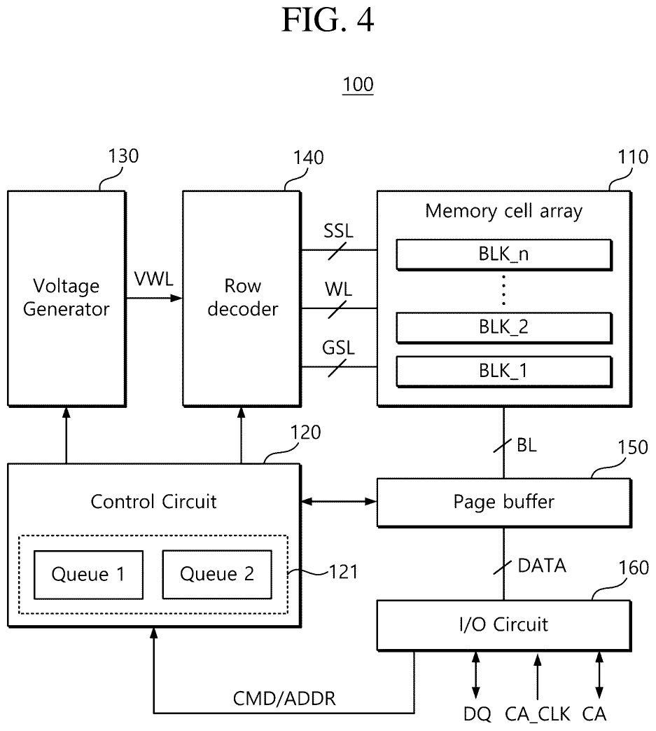

FIG. 4 is a block diagram of a non-volatile memory device according to at least one example embodiment. A non-volatile memory device 100 of FIG. 4 may correspond to the non-volatile memory device 100 of FIG. 1. Referring to FIG. 4, the non-volatile memory device 100 may include a memory cell array 110, a control circuit 120, a voltage generator 130, a row decoder 140, a page buffer 150, and an input/output (I/O) circuit 160.

The memory cell array 110 includes a plurality of memory blocks BLK_1 to BLK_n. Each memory block may have a vertical three-dimensional structure, but the example embodiments are not limited thereto. Each memory block may include a plurality of pages. Each page may include a plurality of memory cells. Each memory block may be a unit for an erase operation, and each page may be a unit for a read operation or a program operation.

The memory cell array 110 may be formed in a direction, perpendicular to a substrate. Gate electrode layers and insulation layers may be alternately deposited on the substrate. Each memory block may be connected to a string select line SSL, a plurality of wordlines, and a ground select line GSL. The number of stacked gate electrode layers, on which the wordlines of the memory cell array 110 are formed, increases as product generations develop.

The row decoder 140 may select a wordline of the memory cell array 110 in response to an address ADDR. The row decoder 140 may provide a wordline voltage VWL, supplied from the voltage generator 130, to the memory cell array 110 through the select lines SSL and GSL and the wordlines WL. The row decoder 140 may select a wordline during a program operation or a read operation. The row decoder 140 may provide a program voltage or a read voltage to the selected wordline.

The voltage generator 130 may generate the wordline voltage VWL used to read or write data under the control of the control circuit 120. The wordline voltage VWL may be provided to a selected wordline or an unselected wordline through the row decoder 140. To this end, the voltage generator 130 may include a charge pump, not illustrated. The voltage generator 130 may generate a wordline voltage to be provided during a program operation or a wordline voltage to be provided during a read operation.

The page buffer 150 may be connected to the memory cell array 110 through a bitline. The page buffer 150 may precharge or sense bitlines in response to a page buffer control signal provided from the control circuit 120. The page buffer 150 may operate as a write driver or a sense amplifier depending on operation mode. The page buffer 150 may apply a bitline voltage, corresponding to the data to be programmed, to a selected bitline during a program operation. The page buffer 150 may sense a current or voltage of a selected bitline to detect data stored in the memory cell during a read operation.

The input/output circuit 160 may receive data, commands, and addresses provided from the controller 200. The input/output circuit 160 may receive data DATA, commands CMD, and addresses ADDR based on an SCA protocol. For example, the input/output circuit 160 may parse commands CMD and addresses ADDR, provided in the form of a packet through the command/address line CA, and transmit the farsed CMD and ADDR to the control circuit 120. The commands CMD may include the above-mentioned insert queue command and queue status read command. The input/output circuit 160 may transmit data DATA, received through the data line DQ, to the page buffer 150.

The control circuit 120 is configured to control the overall operation of the non-volatile memory device 100. The control circuit 120 may perform a program operation, a read operation, an erase operation, or the like, in response to a command CMD and/or an address ADDR.

For example, the control circuit 120 may include a queue interface 121. The queue interface 121 may include at least two command queues in which operation commands are stored. The control circuit 120 may perform operations corresponding to the operation commands stored in the command queues.

According to at least one example embodiment, the queue interface 121 may include a first command queue Queue 1 and a second command queue Queue 2. The control circuit 120 may prioritize an operation command stored in the second command queue Queue 2, over an operation command stored in the first command queue Queue 1. For example, when a second operation command is stored in the second command queue Queue 2 while the control circuit 120 is performing an operation corresponding to a first operation command stored in the first command queue Queue 1, the control circuit 120 may suspend the operation corresponding to the first operation command and perform the operation corresponding to the second operation command. The first command queue Queue 1 may be referred to as a normal command queue and the second command queue Queue 2 may be referred to as a priority command queue, but the example embodiments are not limited thereto.

The control circuit 120 may store an operation command in one of the first command queue Queue 1 or the second command queue Queue 2 based on queue type information included in an insert queue command. For example, when the insert queue command includes queue type information corresponding to the first command queue Queue 1 and an operation command, the control circuit 120 may store the operation command in the first command queue Queue 1. Similarly, when the insert queue command includes queue type information corresponding to the second command queue Queue 2 and an operation command, the control circuit 120 may store the operation command in the second command queue Queue 2.

For example, when a situation arises in which a specific operation command needs to be processed urgently, the controller 200 may generate an insert queue command including the specific operation command and queue type information corresponding to the second command queue Queue 2 and transmit the insert queue command to the non-volatile memory device 100 to prioritize the specific operation command over other operation commands.

The control circuit 120 may perform a resume operation on a suspended operation command. For example, when an operation corresponding to a first operation command stored in the first command queue Queue 1 is suspended and an operation corresponding to a second operation command stored in the second command queue Queue 2 is performed first, the control circuit 120 may resume the operation corresponding to the first operation command after the operation corresponding to the second operation command is completed.

According to at least one example embodiment, the control circuit 120 may determine whether to resume the suspended operation command, based on resume information corresponding to the operation command.

For example, the resume information included in an insert queue command including the first operation command may have a first value corresponding to “Resume ON.” When the operation corresponding to the first operation command is suspended and the operation corresponding to a second operation command is completed, the control circuit 120 may resume the operation corresponding to the first operation command.

The resume information included in an insert queue command including the first operation command may have a second value corresponding to “Resume OFF.” Even when the operation corresponding to the first operation command is suspended and the operation corresponding to a second operation command is completed, the control circuit 120 may not resume the operation corresponding to the first operation command.

For example, the controller 200 may set whether to automatically resume the operation command included in the insert queue through the resume information included in the insert queue command. According to at least one example embodiment, the controller 200 may also apply a separate resume command to the non-volatile memory device 100 to resume an operation on the suspended operation command.

According to the above-described example embodiments, a suspend-resume operation may be performed in response to an operation command being stored in a command queue Queue 2 with a higher priority, among the command queues Queue 1 and Queue 2 provided in the non-volatile memory device 100. The suspend-resume operation is performed without requiring separate suspend commands, status read commands, or resume commands, so that the performance of the storage device 10 may be improved.

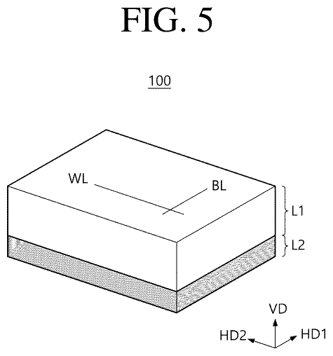

FIG. 5 is a schematic block diagram illustrating a structure of a non-volatile memory device according to at least one example embodiment. A non-volatile memory device 100 of FIG. 5 may be the non-volatile memory device 100 of FIGS. 1 and 4, but the example embodiments are not limited thereto. Referring to FIG. 5, the non-volatile memory device 100 may include a first semiconductor layer L1 and a second semiconductor layer L2. The first semiconductor layer L1 may be stacked in a vertical direction VD relative to the second semiconductor layer L2. For example, the second semiconductor layer L2 may be disposed below the first semiconductor layer L1 in the vertical direction VD. Accordingly, the second semiconductor layer L2 may be disposed closer to a substrate.

According to at least one example embodiment, the memory cell array 110 of FIG. 4 may be formed in the first semiconductor layer L1. In addition, peripheral circuits corresponding to the control circuit 120, voltage generator 130, row decoder 140, page buffer 150, and input/output circuit 160 of FIG. 4 may be formed in the second semiconductor layer L2. Accordingly, the non-volatile memory device 100 may have a structure in which the memory cell array 110 is disposed above the peripheral circuits 120, 130, 140, 150, and 160, for example, a cell over periphery (COP) structure. The COP structure may effectively reduce a horizontal area and improve the integration density of the non-volatile memory device 100.

According to at least one example embodiment, the second semiconductor layer L2 may include a substrate, and peripheral circuits 120, 130, 140, 150, and 160 may be formed in the second semiconductor layer L2 by forming transistors and metal patterns for wiring the transistors on the substrate. After the peripheral circuits 120, 130, 140, 150, and 160 are formed in the second semiconductor layer L2, the first semiconductor layer L1 including the memory cell array 110 may be formed. Metal patterns may then be formed to electrically connect the wordlines WL and bitlines BL of the memory cell array 110 to the peripheral circuits 120, 130, 140, 150, and 160 formed in the second semiconductor layer L2. For example, the bitlines BL may extend in a first horizontal direction HD1, and the wordlines WL may extend in a second horizontal direction HD2.

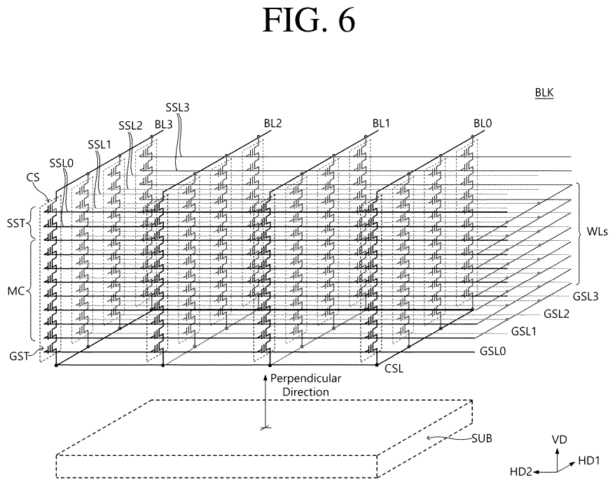

FIG. 6 is a circuit diagram illustrating an example of a structure of a memory block constituting the memory cell array of FIG. 4. Referring to FIG. 6, cell strings CS may be formed between bitlines BL0, BL1, BL2, and BL3 and a common source line CSL to constitute a memory block BLK.

A plurality of cell strings may be formed between the bitline BL0 and the common source line CSL. A string select transistors SST of the cell strings CS may be connected to a corresponding bitlines BL. A ground select transistors GST of the cell strings CS may be connected to a common source line CSL. The memory cells MCs may be provided between the string select transistor SST and the ground select transistor GST of the cell string CS.

Each of the cell strings CS may include a ground select transistor GST. The ground select transistors included in the cell strings CS may be controlled by a ground select line GSL. Alternatively, although not illustrated, cell strings corresponding to each row may be controlled by different ground select lines.

A circuit structure of memory cells included in a single memory block BLK has been briefly described above. However, the circuit structure of the illustrated memory block BLK is only a simplified structure for ease of description, and an actual memory block is not limited to the illustrated example. For example, it will be well understood that more semiconductor layers, bitlines BLs, and string select lines SSLs may be included in a single physical block.

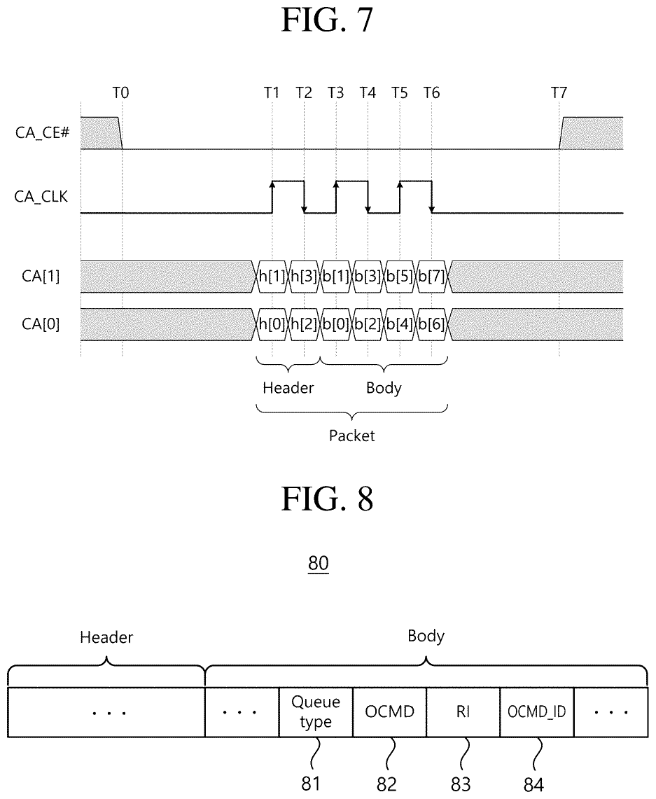

FIG. 7 is a diagram illustrating an example of a packet configuration applied to a separate command/address (SCA) protocol according to at least one example embodiment.

Referring to FIG. 7, the controller 200 may transmit commands, addresses, and/or data to the non-volatile memory device 100 in the form of a packet through a command/address line CA. FIG. 7 illustrates an example in which a packet transmitted through the command/address line CA includes a 4-bit header and an 8-bit body. However, the number of bits in the header or body of the packet may vary according to some example embodiments.

At time T0, the controller 200 may activate a chip enable signal CA_CE#to a low level to select a chip of the non-volatile memory device 100 to which an SCA protocol is applied. The non-volatile memory device 100 may prepare for data exchange through the command/address line CA in response to the chip enable signal CA_CE#being activated.

At time T1, the controller 200 may sequentially transmit a packet header Header through the command/address line CA in synchronization with transitions of a clock signal CA_CLK. At time T1, head bits h[0] and h[1] of the command/address line CA may be transmitted to the input/output circuit 160 of the non-volatile memory device 100 in synchronization with a rising edge of the clock signal CA_CLK. At time T2, head bits h[2] and h[3] of the command/address line CA may be transmitted to the input/output circuit 160 of the non-volatile memory device 100 in synchronization with a falling edge of the clock signal CA_CLK.

At time T3, the controller 200 may sequentially transmit a packet body Body through the command/address line CA in synchronization with transition of the clock signal CA_CLK. At time T3, body bits b[0] and b[1] of the command/address line CA may be transmitted to the input/output circuit 160 of the non-volatile memory device 100 in synchronization with a rising edge of the clock signal CA_CLK. At time T4, the body bits b[2] and b[3] of the command/address line CA may be transmitted to the input/output circuit 160 of the non-volatile memory device 100 in synchronization with a falling edge of the clock signal CA_CLK. At time T5, the body bits b[4] and b[5] of the command/address line CA may be transmitted to the input/output circuit 160 of the non-volatile memory device 100 in synchronization with a rising edge of the clock signal CA_CLK. At time T6, the body bits b[6] and b[7] of the command/address line CA may be transmitted to the input/output circuit 160 of the non-volatile memory device 100 in synchronization with a falling edge of the clock signal CA_CLK. When the packet transmission is complete, the controller 200 may deactivate the chip enable signal CA_CE #at time T7.

Bit values of the header h[0], h[1], h[2], and h[3] and body b[0], b[1], b[2], b[3], b[4], b[5], b[6], and b[7] of a packet transmitted through the command/address line CA may define the type of command, address, and various types of information related to the command.

For example, the above-described insert queue command or queue status read command may also be provided in the form of a packet transmitted through the command/address line CA.

FIG. 8 is a diagram illustrating the structure of an insert queue command according to at least one example embodiment. Referring to FIG. 8, the insert queue command 80 may have the form of a packet transmitted through the command/address line CA. The packet may include a header and a body, as described above in FIG. 7.

According to at least one example embodiment, the insert queue command 80 may include queue type information 81 corresponding to one of the command queues Queue 1 and Queue 2 included in the non-volatile memory device 100.

For example, when the non-volatile memory device 100 includes two command queues, the queue type information may be represented through a single bit among a plurality of bits included in the body. For example, when the non-volatile memory device 100 includes a first command queue Queue 1 and a second command queue Queue 2, a bit value of “0” corresponding to the queue type information 81 may correspond to the first command queue Queue 1 and a bit value of “1” may correspond to the second command queue Queue 2. When the non-volatile memory device 100 includes four command queues, the queue type information 81 may be represented through two bits among a plurality of bits included in the body. For example, when the non-volatile memory device 100 includes a first command queue Queue 1, a second command queue Queue 2, a third command queue Queue 3, and a fourth command queue Queue 4, a bit value of “00” corresponding to the queue type information 81 may correspond to the first command queue Queue 1, a bit value of “01” may correspond to the second command queue Queue 2, a bit value of “10” may correspond to the third command queue Queue 3, and a bit value of “11” may correspond to the fourth command queue Queue 4.

The insert queue command 80 may include an operation command OCMD 82. The operation command 82 may include a program command, a read command, or an erase command. The operation command 82 may be represented through a portion of the plurality of bits included in the body.

The non-volatile memory device 100 may determine a command queue to store the operation command 82, based on the queue type information 81. For example, when the queue type information 81 included in the insert queue command 80 corresponds to the first command queue Queue 1 and the operation command 82 corresponds to a program command, the non-volatile memory device 100 may store the program command, included in the insert queue command 80, in the first command queue Queue 1.

According to at least one example embodiment, the insert queue command 80 may further include resume information RI 83. The resume information 83 may indicate whether to resume an operation corresponding to the operation command 82.

For example, when the execution of the operation command 82 is suspended and another operation command is executed first, the non-volatile memory device 100 may check the resume information 83 corresponding to the operation command 82 after the execution of the other operation command is completed. When a bit value corresponding to the resume information 83 is “0,” the non-volatile memory device 100 may resume the operation command 82. However, when the bit value corresponding to the resume information 83 is “1,” the non-volatile memory device 100 may not resume the operation command 82. In other words, the control circuit 120 may refrain from resuming the operation corresponding to the suspended operation, in spite of the completion of the operation of the second operation command, in cases wherein the resume information 83 indicates the operation should not be resumed and a resume command has not been received.

According to at least one example embodiment, the insert queue command 80 may include an operation command identifier OCMD_ID 84. The non-volatile memory device 100 may store a processing status of the operation command 82 stored in the command queue by matching the processing status with the operation command identifier 84. Therefore, when the controller 200 transmits a queue status read command, the non-volatile memory device 100 may transmit the status information of each command queue to the controller 200 in response to the queue status read command. The status information of each command queue may include information on the processing status of each operation command stored in each command queue.

FIG. 8 illustrates an example in which the queue type information 81, the resume information 83, and the operation command identifier 84 are included in the body of the packet, but some example embodiments are not limited thereto. According to at least one example embodiment, at least one of the queue type information 81, the resume information 83, and the operation command identifier 84 may be included in the header of the packet. The insert queue command 80 described in FIG. 8 may be generated by the queue manager 240 of FIG. 3, but some example embodiments are not limited thereto.

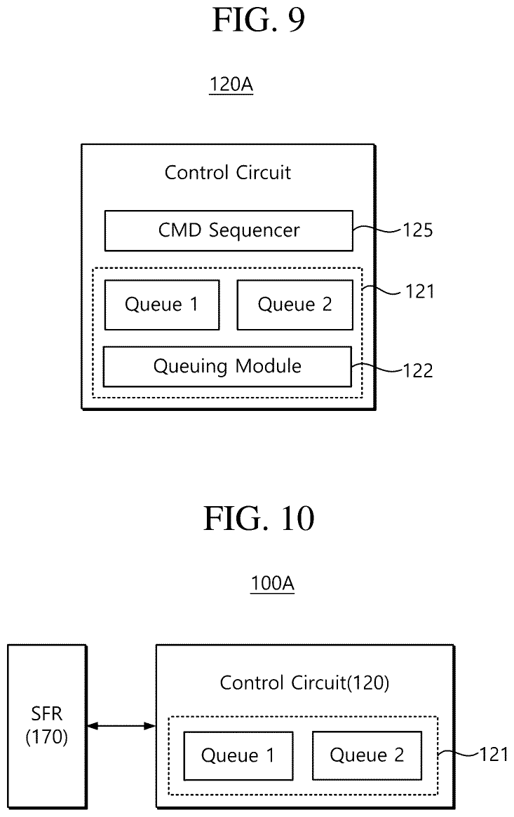

FIG. 9 is a block diagram illustrating the configuration of a control circuit according to at least one example embodiment. A control circuit 120A of FIG. 9 may be an implementation example of the control circuit 120 included in the non-volatile memory device 100 of FIGS. 1 and 4, but some example embodiments are not limited thereto. Descriptions of features identical or similar to those in the above embodiments are omitted to avoid redundancy.

Referring to FIG. 9, the control circuit 120A may include a queue interface 121 including command queues Queue 1 and Queue 2 and a queuing module 122. When an insert queue command is received through an input/output circuit 160, a queuing module 122 may store an operation command included in the insert queue command in one of the command queues Queue 1 and Queue 2. According to at least one example embodiment, the queuing module 122 may determine a command queue to store the operation command, based on the queue type information included in the insert queue command. For example, when the insert queue command includes queue type information corresponding to the first command queue Queue 1, the queuing module 122 may store an operation command in the first command queue Queue 1. Similarly, when the insert queue command includes queue type information corresponding to the second command queue Queue 2, the queuing module 122 may store an operation command in the second command queue Queue 2.

The control circuit 120A may include a command sequencer 125. The command sequencer 125 may decode operation commands stored in the command queues Queue 1 and Queue 2 included in the queue interface 121 and determine the processing order of the decoded operation commands. According to at least one example embodiment, the command sequencer 125 may prioritize an operation command stored in one of the command queues Queue 1 and Queue 2. For example, when a second operation command is stored in the second command queue Queue 2 while the command sequencer 125 is performing an operation corresponding to a first operation command stored in the first command queue Queue 1, the command sequencer 125 may suspend an operation corresponding to the first operation command and perform an operation corresponding to the second operation command.

FIG. 10 is a block diagram illustrating the configuration of a non-volatile memory device according to at least one example embodiment. A non-volatile memory device 100A of FIG. 10 may be an implementation example of the non-volatile memory device 100 of FIGS. 1 and 4, but some example embodiments are not limited thereto.

Referring to FIG. 10, the non-volatile memory device 100A may include a control circuit 120 and a special function register (SFR) 170. It is understood that the non-volatile memory device 100A may further include other components included in the non-volatile memory device 100 of FIG. 1 or FIG. 4, and descriptions of features identical or similar to those in the above example embodiments are omitted to avoid redundancy.

The SFR 170 may set a mode of the non-volatile memory device 100A. The non-volatile memory device 100A may operate in various modes based on the setting values set in the SFR 170. According to at least one example embodiment, the SFR 170 may have a setting value to determine whether to resume an operation corresponding to a suspended operation command.

For example, when a first value is set in the SFR 170 in relation to the resume operation, the non-volatile memory device 100A may operate in an automatic resume mode. In the automatic resume mode, the control circuit 120 may automatically resume an operation corresponding to a suspended operation command. For example, when an operation corresponding to a first operation command is suspended and an operation corresponding to a second operation command is performed first, the control circuit 120 may resume an operation corresponding to the first operation command in response to the completion of the operation corresponding to the second operation command, in the automatic resume mode.

When a second value is set in the SFR 170 in relation to the resume operation, the non-volatile memory device 100A may operate in a manual resume mode. In the manual resume mode, the control circuit 120 may not automatically resume an operation corresponding to a suspended operation command. For example, in the above example, the control circuit 120 may not resume an operation corresponding to the first operation command even after an operation corresponding to the second operation command is completed. In other words, the control circuit 120 may refrain from resuming the operation corresponding to the suspended operation, in spite of the completion of the operation of the second operation command, in cases wherein the SFR 170 is in the manual resume mode and a resume command has not been received. The controller 200 may transmit a separate resume command to the non-volatile memory device 100A to cause the operation corresponding to the first operation command to be resumed.

The setting value of the SFR 170 related to the resume operation may be changed by the controller 200 even while the non-volatile memory device 100A is operating.

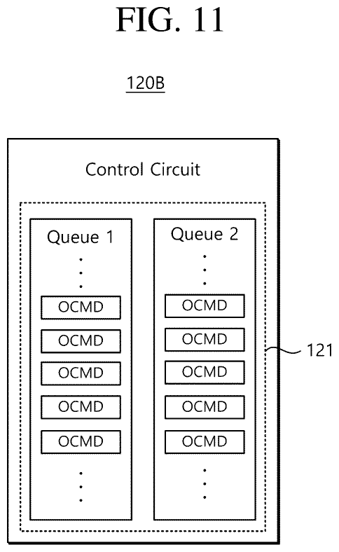

FIG. 11 is a block diagram illustrating the configuration of a control circuit according to at least one example embodiment. A control circuit 120B of FIG. 11 may be an implementation example of the control circuit 120, 120A of FIGS. 1, 4, 9, and 10, but some example embodiments are not limited thereto. Descriptions of features identical or similar to those in the above embodiments are omitted to avoid redundancy.

Referring to FIG. 11, a queue interface 121 of the control circuit 120B may include a first command queue Queue 1 and a second command queue Queue 2. Each command queue may store a plurality of operation commands OCMD. The control circuit 120B may prioritize at least a portion of the operation commands stored in the second command queue Queue 2 over the operation commands stored in the first command queue Queue 1. The prioritization may include the above-described suspend-resume operation.

According to at least one example embodiment, the control circuit 120B may process the operation commands stored in the first command queue Queue 1 after processing all the operation commands stored in the second command queue Queue 2.

Alternatively, according to at least one example embodiment, the control circuit 120B may prioritize the operation commands stored in the second command queue Queue 2, over the operation commands stored in the first command queue Queue 1. In addition, the control circuit 120B may process a second number of operation commands stored in the first command queue Queue 1 each time processing a first number of operation commands, among the operation commands stored in the second command queue Queue 2. For example, the control circuit 120B may process a single operation command stored in the first command queue Queue 1 each time processing three operation commands stored in the second command queue Queue 2, but the example embodiments are not limited thereto.

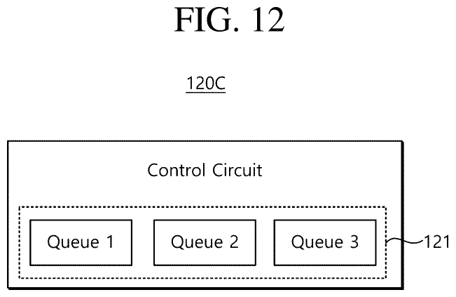

FIG. 12 is a block diagram illustrating the configuration of a control circuit according to at least one example embodiment. The control circuit 120C of FIG. 12 may be an implementation example of the control circuits 120, 120A, and 120B of FIGS. 1, 4, 9, 10, and 11, but some example embodiments are not limited thereto. Descriptions of features identical or similar to those in the above embodiments are omitted to avoid redundancy.

Referring to FIG. 12, a queue interface 121 of a control circuit 120C may include a first command queue Queue 1, a second command queue Queue 2, and a third command queue Queue 3.

According to at least one example embodiment, the first command queue Queue 1 may be a normal command queue, the second command queue Queue 2 may be a priority command queue, and the third command queue Queue 3 may be a highest-priority command queue. The control circuit 120C may prioritize operation commands stored in the second command queue Queue 2, over operation commands stored in the first command queue Queue 1. The control circuit 120C may process a second number of operation commands stored in the first command queue Queue 1 each time processing a first number of operation commands stored in the second command queue Queue 2, among the operation commands stored in the second command queue Queue 2.

The control circuit 120C may always prioritize operation commands stored in the third command queue Queue 3, over operation commands stored in the first command queue Queue 1 and the second command queue Queue 2. The control circuit 120C may process operation commands stored in the first or second command queues Queue 1, Queue 2 after processing all the operation commands stored in the third command queue Queue 3.

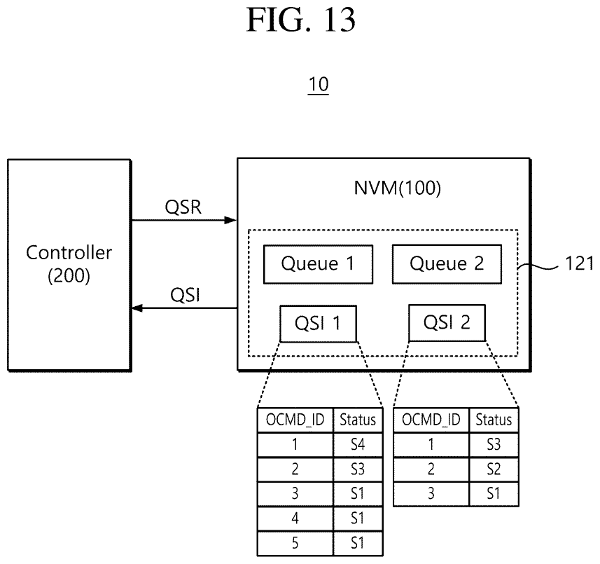

FIG. 13 is a diagram illustrating an example of a queue status read operation according to at least one example embodiment. A storage device 10 of FIG. 13 may correspond to the storage device 10 of FIG. 1. Referring to FIG. 13, the storage device 10 may include a controller 200 and a non-volatile memory device (NVM) 100. Descriptions of features identical or similar to those in the above embodiments are omitted to avoid redundancy.

According to at least one example embodiment, the non-volatile memory device 100 may store status information for each of the command queues Queue 1 and Queue 2. The status information for each command queue may include information on a processing status of each operation command stored in a corresponding command queue. For example, a processing status of each operation command may include one of a first state S1 to a fourth state S4. The first state S1 may indicate a processing-pending state, the second state S2 may indicate a processing-in-progress state, the third state S3 may indicate a processing completed state, and the fourth state S4 may indicate a processing failed state.

To this end, the non-volatile memory device 100 may store a processing status of each operation command in a command queue by matching the processing status to an operation command identifier OCMD_ID. Information on the processing status matching the operation command identifier OCMD_ID may be stored in the queue interface 121. However, some example embodiments are not limited thereto, and the information may also be stored in a separate storage space provided within the non-volatile memory device 100.

The controller 200 may transmit a queue status read command QSR to the non-volatile memory device 100 to check the processing status of operation commands transmitted to the non-volatile memory device 100.

The non-volatile memory device 100 may transmit queue status information QSI to the controller 20 in response to the queue status read command QSR being received. The queue status information QSI may include status information for each of the plurality of command queues included in the queue interface 121. In the example of FIG. 13, the non-volatile memory device 100 may transmit status information QSI 1 of the first command queue Queue 1 and status information QSI 1 and QSI 2 of the second command queue Queue 2 to the controller 200 in response to a queue status read command QSR.

The controller 200 may check processing statuses of the operation commands transmitted to the non-volatile memory device 100, based on the queue status information QSI.

The operations of the non-volatile memory device 100 described in FIG. 13 may be performed by the control circuit 120 of the non-volatile memory device 100, but the some example embodiments are not limited thereto.

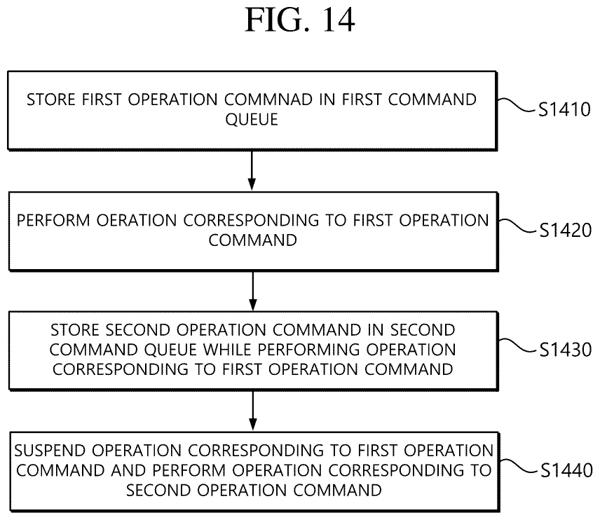

FIG. 14 is a flowchart illustrating a method of operating a non-volatile memory device according to at least one example embodiment.

Referring to FIG. 14, in operation S1410, the non-volatile memory device 100 may store a first operation command in the first command queue Queue 1. For example, the non-volatile memory device 100 may receive a first insert queue command including queue type information corresponding to the first command queue Queue 1 and the first operation command. Accordingly, the non-volatile memory device 100 may store the first operation command in the first command queue Queue 1 based on the queue type information.

In operation S1420, the non-volatile memory device 100 may perform an operation corresponding to the first operation command. The first operation command may be either a program operation command or an erase operation command, but some example embodiments are not limited thereto.

In operation S1430, the non-volatile memory device 100 may store a second operation command in the second command queue Queue 2 while performing the operation corresponding to the first operation command. For example, the non-volatile memory device 100 may receive a second insert queue command while performing the operation corresponding to the first operation command. The second insert queue command may include queue type information corresponding to the second command queue Queue 2 and the second operation command. Accordingly, the non-volatile memory device 100 may store the second operation command in the second command queue Queue 2 based on the queue type information. The non-volatile memory device 100 may communicate with the controller 200 using a separate command/address (SCA) protocol. Therefore, the non-volatile memory device 100 may receive the second insert queue command through the command/address line CA, separated from the data line DQ, even while performing the operation corresponding to the first operation command.

In operation S1440, the non-volatile memory device 100 may suspend the operation corresponding to the first operation command and perform the operation corresponding to the second operation command. For example, the non-volatile memory device 100 may suspend the operation corresponding to the first operation command being performed and perform the operation corresponding to the second operation command, in response to the second operation command being stored in the second command queue Queue 2.

The non-volatile memory device 100 may resume the operation corresponding to the first operation command when the operation corresponding to the second operation command is completed. According to an embodiment, the non-volatile memory device 100 may determine whether to resume the first operation command based on the resume information included in the first insert queue command. Alternatively, according to an embodiment, the non-volatile memory device 100 may or may not resume the first operation command depending on the mode set by the SFR 170.

According to at least one example embodiment, the non-volatile memory device 100 may receive a queue status read command QSR from the controller 200. The non-volatile memory device 100 may transmit the status information of each of the first command queue Queue 1 and the second command queue Queue 2 to the controller 200 in response to the queue status read command. The status information may include information on a processing status of each of the operation commands stored in the first command queue Queue 1 and the second command queue Queue 2. To this end, the non-volatile memory device 100 may store the processing status of each of the operation commands stored in the command queue by matching the processing status to an operation command identifier OCMD_ID.

According to the above-described embodiments, a storage device, a non-volatile memory device, and a method of operating the non-volatile memory device, all of which offer improved performance, may be provided.

As set forth above, according to some example embodiments, a storage device, a non-volatile memory device, and a method of operating the nonvolatile memory device, all of which offer improved performance.

While some example embodiments have been shown and described above, it will be apparent to those skilled in the art that modifications and variations could be made without departing from the scope of the present inventive concept as defined by the appended claims.

What is claimed is:

1. A storage device comprising:
a controller configured to transmit an insert queue command, the insert queue command comprising an operation command; and
a non-volatile memory device comprising a first command queue and a second command queue, the non-volatile memory device configured to store the operation command in one of the first command queue or the second command queue,
wherein the non-volatile memory device is configured to
perform an operation corresponding to a first operation command stored in the first command queue,
store a second operation command in the second command queue while performing the operation corresponding to the first operation command, and
suspend the operation corresponding to the first operation command and perform an operation corresponding to the second operation command when the second operation command is stored in the second command queue.

2. The storage device of claim 1, wherein the controller is configured to transmit the insert queue command to the non-volatile memory device through a command/address line separate from a data line.

3. The storage device of claim 1, wherein:
the insert queue command comprises queue type information corresponding to one of the first command queue and the second command queue; and
the non-volatile memory device is configured to store the operation command in one of the first command queue or the second command queue based on the queue type information.

4. The storage device of claim 1, wherein:
the first operation command is at least one of a program command or an erase command; and
the second operation command is a read command.

5. The storage device of claim 1, wherein the non-volatile memory device is configured to resume the operation corresponding to the first operation command when the operation corresponding to the second operation command is completed.

6. The storage device of claim 1, wherein the insert queue command comprises resume information; and
the non-volatile memory device is configured to,
resume the operation corresponding to the first operation command in response to the operation corresponding to the second operation command being completed when the resume information corresponds to the first operation command and has a first value, and
refrain from resuming the operation corresponding to the first operation command in spite of the operation corresponding to the second operation command being completed when the resume information corresponding to the first operation command has a second value different from the first value.

7. The storage device of claim 1, wherein the non-volatile memory device comprises a special function register (SFR); and
the non-volatile memory device is configured to
resume the operation corresponding to the first operation command in response to the operation corresponding to the second operation command being completed and a first value is set in the SFR, and
refrain from resuming the operation corresponding to the first operation command in spite of the operation corresponding to the second operation command being completed when a second value is set in the SFR, the second value different from the first value.

8. The storage device of claim 1, wherein:
the controller is configured to transmit a queue status read command to the non-volatile memory device;
the non-volatile memory device is configured to transmit status information of the first command queue and the second command queue to the controller in response to the queue status read command; and
the status information comprises information on a processing status of each of the operation commands stored in the first command queue and the second command queue.

9. The storage device of claim 1, wherein the non-volatile memory device is configured to, when a plurality of operation commands are stored in each of the first command queue and the second command queue, prioritize at least a portion of the plurality of operation commands stored in the second command queue over the plurality of operation commands stored in the first command queue.

10. A non-volatile memory device comprising:
a memory cell array; and
a control circuit comprising a first command queue and a second command queue, the control circuit configured to cause the memory cell array to perform operations corresponding to operation commands stored in the first command queue and the second command queue,
wherein the control circuit is configured to
perform an operation corresponding to a first operation command stored in the first command queue,
store a second operation command in the second command queue while performing the operation corresponding to the first operation command, and
suspend the operation corresponding to the first operation command and perform an operation corresponding to the second operation command when the second operation command is stored in the second command queue.

11. The non-volatile memory device of claim 10, wherein the operation commands are respectively included in insert queue commands and provided to the non-volatile memory device through a command/address line separate from a data line.

12. The non-volatile memory device of claim 11, wherein each of the insert queue commands comprises queue type information corresponding to one of the first command queue or the second command queue; and
the control circuit is configured to store each of the operation commands in one of the first command queue or the second command queue based on the queue type information.

13. The non-volatile memory device of claim 10, wherein the control circuit is configured to resume the operation corresponding to the first operation command when the operation corresponding to the second operation command is completed.

14. The non-volatile memory device of claim 11, wherein each of the insert queue commands comprises resume information; and
the control circuit is configured to,
resume the operation corresponding to the first operation command in response to the operation corresponding to the second operation command being completed when the resume information corresponds to the first operation command and has a first value; and
refrain from resuming the operation corresponding to the first operation command in spite of completion of the operation corresponding to the second operation command when the resume information corresponding to the first operation command has a second value different from the first value.

15. The non-volatile memory device of claim 10, further comprising:
a special function register (SFR) for setting whether to resume an operation corresponding to a suspended operation command,
wherein the control circuit is configured to:
resume the operation corresponding to the first operation command in response to the operation corresponding to the second operation command being completed and a first value is set in the SFR, and
refrain from resuming the operation corresponding to the first operation command in spite of completion of the operation corresponding to the second operation command when a second value is set in the SFR, the second value different from the first value.

16. The non-volatile memory device of claim 12, wherein the control circuit is configured to
store each of the operation commands in one of the first command queue and the second command queue based on the queue type information;
decode the operation commands stored in the first command queue and the second command queue; and
determine a processing order of the decoded operation commands.

17. The non-volatile memory device of claim 16, wherein the control circuit is configured to, when a plurality of operation commands are stored in each of the first command queue and the second command queue, prioritize at least a portion of the operation commands stored in the second command queue over the operation commands stored in the first command queue.

18. The non-volatile memory device of claim 10, wherein:
the control circuit is configured to transmit status information of the first command queue and the second command queue to a controller in response to a queue status read command being received from the controller; and
the status information comprises information on a processing status of each of the operation commands stored in the first command queue and the second command queue.

19. A method of operating a non-volatile memory device, the method comprising:
storing a first operation command in a first command queue when a first insert queue command comprising the first operation command is received;
performing an operation corresponding to the first operation command;
storing a second operation command in a second command queue in response to a second command comprising the second operation command being received, the storing the second operation command performed while performing the operation corresponding to the first operation command; and
suspending the operation corresponding to the first operation command and performing an operation corresponding to the second operation command in response to the second operation command being stored in the second command queue.

20. The method of claim 19, comprising:
resuming the operation corresponding to the first operation command in response to completion of the operation corresponding to the second operation command.
